(19) United States
(12) Patent Application Publication
(10) Pub. No.: US 2011/0234584 A1
(43) Pub. Date: Sep. 29, 2011

(54) HEAD-MOUNTED DISPLAY DEVICE

(75) Inventor: Hiroshi ENDO, Saitama (JP)

(73) Assignee: FUJIFILM CORPORATION, Tokyo (JP)

(21) Appl. No.: 13/017,219

(22) Filed: Jan. 31, 2011

(30) Foreign Application Priority Data
Mar. 25, 2010 (JP) 2010-070054

(51) Int. Cl. G06T 15/00; G09G 5/00

(52) U.S. Cl. 345/419; 345/8

(57) ABSTRACT

An HMD includes left and right camera units which have wide-angle lenses, capture the image of a real space, and capture a left viewpoint image and a right viewpoint image. A main image is extracted from a central portion of each viewpoint image, and a left sub-image and a right sub-image are extracted from a peripheral portion of each viewpoint image. The distortion of the wide-angle lens in each main image is corrected, and the corrected main images are displayed in front of the left and right eyes as a stereo image. The left sub-image and the right sub-image are displayed on the left and right sides of the main image without being corrected.

### BACKGROUND OF THE INVENTION

1. Field of the Invention

The present invention relates to a head-mounted display device that is worn on a head of a wearer such that the wearer can view an image.

2. Description of the Related Art

A head-mounted display device (hereinafter, referred to as an HMD) is known which is worn on a head of a wearer and displays a video in front of eyes of the wearer. The HMD is used for various purposes. One of the purposes of the HMD is to display various kinds of additional information (hereinafter, referred to as AR information) superimposed on a real space (external scene), thereby providing information. For example, a light transmissive HMD and a video see-through HMD are used for the purpose. In the light transmissive HMD, the real space and the AR information displayed on liquid crystal are superimposed by, for example, a half mirror such that they can be observed by the user. In the video see-through HMD, a video camera captures the image of the real space from the viewpoint of the user, and an external video obtained by the image capture is composed with the AR information such that the user can observe the composed information.

In the video see-through HMD, since the visual field that can be observed by the wearer is limited by the angle of view of the video camera, the visual field is generally narrower than that in a non-mounted state. Therefore, when the wearer moves with the HMD worn on the head, the wearer is likely to contact the surroundings, particularly, an obstacle disposed in the left-right direction deviating from the visual field due to the influence of the limit of the visual field.

An HMD is known which includes a detecting sensor that measures a distance between an image output unit provided in front of eyes and an external obstacle. In the HMD, when the obstacle comes close to the distance where it is likely to contact the image output unit, an arm holding the image output unit is moved backward to avoid contact with the obstacle on the basis of the detection result of the detecting sensor (see JP-A-2004-233948).

However, in JP-A-2004-233948 in which a portion of the HMD is moved, in many cases, it is difficult to avoid the obstacle, and the wearer needs to move in order to avoid the obstacle. Therefore, it is preferable to ensure a wide visual field even when the video see-through HMD is worn. It is considered that a wide-angle lens which has a short focal length and is capable of capturing an image in a wide range is used to capture the image of the real space in order to widen the visual field. However, in the wide-angle lens, there is a large distortion in a captured image. Therefore, when the wide-angle lens is used, it is possible to provide a wide visual field to the wearer, but the real space observed by the wearer is distorted, which hinders the action of the wearer.

### SUMMARY OF THE INVENTION

The present invention has been made in view of the above-mentioned problems and an object of the present invention is to provide a head-mounted display device that enables a user to freely move while ensuring a wide visual field.

According to a first aspect of the invention, a head-mounted display device includes: an imaging unit including a pair of left and right cameras each of which captures an image of a real space through a wide-angle lens from left and right viewpoints substantially the same as those of a wearer, the left camera capturing a left viewpoint image, and the right camera capturing a right viewpoint image; an image dividing unit extracting a central portion of each of the left and right viewpoint images as a main image and a peripheral portion of each of the left and right viewpoint images as a sub-image; a distortion correcting unit correcting distortion of the wide-angle lens for the main image; a main image display unit including a left main screen which is provided in front of the left eye of the wearer and displays the main image obtained from the left viewpoint image, and a right main screen which is provided in front of the right eye of the wearer and displays the main image obtained from the right viewpoint image, and the main image display unit stereoscopically displaying the main image; and a sub-image display unit including a sub-screen that displays the sub-image around each of the main screens.

In the head-mounted display device according to a second aspect of the invention, the image dividing unit may extract the sub-image from each of the left and right viewpoint images so as to overlap the sub-image with a portion of the main image.

In the head-mounted display device according to a third aspect of the invention, the image dividing unit may extract the sub-images from the left and right sides of the main image, and the sub-image display unit may display the corresponding sub-images on the sub-screens arranged on the left and right sides of the main screen.

In the head-mounted display device according to a fourth aspect of the invention, the image dividing unit may extract the sub-images from the upper, lower, left, and right sides of the main image, and the sub-image display unit may display the corresponding sub-images on the sub-screens arranged on the upper, lower, left, and right sides of the main screen.

The head-mounted display device according to a fifth aspect of the invention may further include: a motion detecting unit detecting motion of the head of the wearer; a mode control unit setting a display mode to a 3D mode or a 2D mode on the basis of the detection result of the motion detecting unit; and a display switching unit displaying the main image obtained from the left viewpoint image on the left main screen and the main image obtained from the right viewpoint image on the right main screen in the 3D mode, and displays the main image obtained from one of the left and right viewpoint images on each of the left main screen and the right main screen in the 2D mode.

In the head-mounted display device according to a sixth aspect of the invention, when the motion detecting unit detects the motion of the head of the wearer, the mode control unit may set the display mode to the 3D mode. When the motion detecting unit does not detect the motion of the head of the wearer, the mode control unit may set the display mode to the 2D mode.

In the head-mounted display device according to a seventh aspect of the invention, when the speed of the motion detected by the motion detecting unit is equal to or more than a predetermined value, the mode control unit may set the display mode to the 3D mode. When the speed of the motion is less than the predetermined value, the mode control unit may set the display mode to the 2D mode.

The head-mounted display device according to an eighth aspect of the invention may further include: a viewpoint detecting unit detecting a viewpoint position of the wearer on the main image or the sub-image; a mode control unit selecting a 3D mode or a 2D mode as a display mode on the basis of the detection result of the viewpoint detecting unit; a display switching unit displaying the main image obtained from the left viewpoint image on the left main screen and the main image obtained from the right viewpoint image on the right main screen in the 3D mode, and displays the main image obtained from one of the left and right viewpoint images on each of the left main screen and the right main screen in the 2D mode.

The head-mounted display device according to a ninth aspect of the invention may further include: an approach detecting unit detecting an object approaching the wearer using a parallax between the corresponding sub-images obtained from the right viewpoint image and the left viewpoint image; and a notifying unit displaying a notice on the sub-screen on which the sub-image is displayed when the object approaching the wearer is detected in the sub-image.

The head-mounted display device according to a tenth aspect of the invention may further include an additional information composition unit superimposing additional information on the main image or the sub-image to display the main image or the sub-image having the additional information superimposed thereon.

According to the above-mentioned aspects of the invention, the left and right cameras, each having a wide-angle lens, capture the image of a real space and each viewpoint image. A main image and a peripheral sub-image of the main image are extracted from each viewpoint image. The distortion of the wide-angle lens is corrected in the main image and the main image is stereoscopically displayed. The sub-image is displayed around the main image. In this way, the wearer can freely move while observing the main image and also can obtain a peripheral visual field by the sub-image. Therefore, it is possible for the wearer to easily prevent contact with an obstacle.

### BRIEF DESCRIPTION OF THE DRAWINGS

FIG. 1 is a perspective view illustrating the outward structure of an HMD according to an embodiment of the invention;

FIG. 2 is a block diagram illustrating the structure of the HMD;

FIG. 3 is a block diagram illustrating the structure of an image processing unit;

FIGS. 4A and 4B are diagrams illustrating the generation of a main image and each sub-image from a viewpoint image;

FIG. 5 is a block diagram illustrating an image processing unit that changes the display of the main image to a 3D mode or a 2D mode according to the motion of a wearer;

FIG. 6 is a flowchart illustrating the outline of a control process when the display mode is changed to the 3D mode or the 2D mode according to the motion of the wearer;

FIG. 7 is a block diagram illustrating an image processing unit that changes the display of the main image to the 3D mode or the 2D mode according to the movement of a viewpoint of a wearer;

FIG. 8 is a flowchart illustrating the outline of a control process when the display mode is changed to the 3D mode or the 2D mode according to the movement of the viewpoint of the wearer;

FIG. 9 is a block diagram illustrating an image processing unit that causes an approaching object to blink in a left image or a right image;

FIG. 10 is a flowchart illustrating a control process when the approaching object blinks in the left image or the right image; and

FIG. 11 is a diagram illustrating an example of the display of the sub-images on the upper, lower, left, and right sides of the main image.

### DESCRIPTION OF THE PREFERRED EMBODIMENTS

### First Embodiment

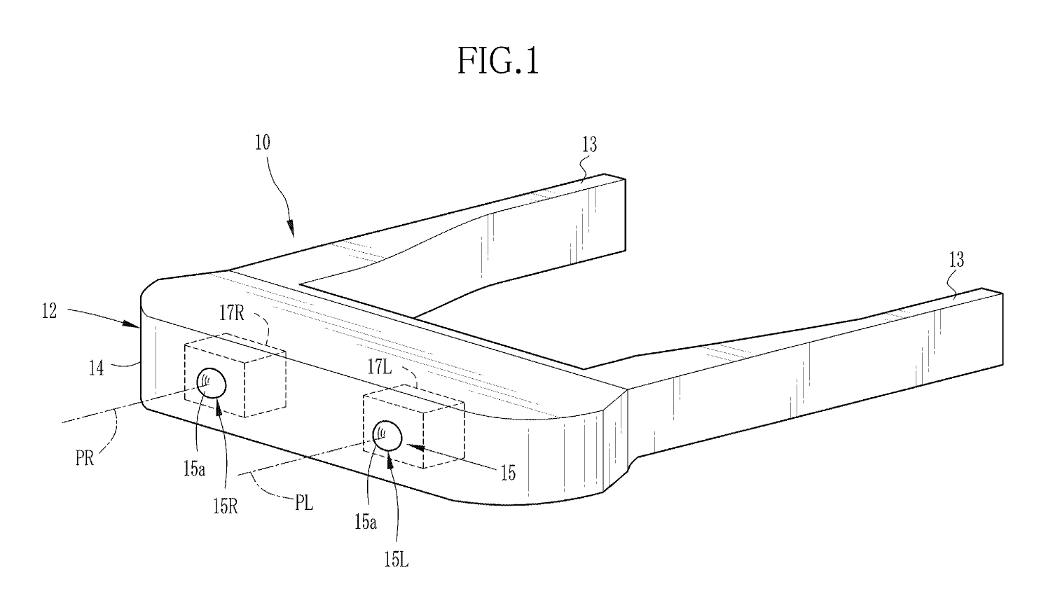

FIG. 1 shows the outward appearance of an HMD (head-mounted display device) according to an embodiment of the invention. An HMD 10 has a goggle shape and includes an anterior eye unit 12 and a pair of temples (bows) 13 that is provided integrally with the anterior eye unit 12. The HMD 10 is worn on the head of the user using the temples 13. The anterior eye unit 12 includes a box-shaped housing 14 that is provided so as to cover the front of the eyes of the wearer, a camera unit 15, and left and right display units 17L and 17R and various kinds of image processing circuits that are provided in the housing 14.

The camera unit 15 includes a left camera 15L and a right camera 15R. Each of the cameras 15L and 15R includes an imaging lens 15a. The imaging lenses 15a are arranged in the horizontal direction on a front surface of the housing 14 in front of the left and right eyes. The imaging lenses 15a are arranged such that a gap between optical axes PL and PR thereof is substantially equal to a width of the eyes. The camera unit 15 captures a stereo image from substantially the same left and right viewpoints as those of the wearer. The stereo image includes a left viewpoint image obtained by capturing the real space (external scene) with the left camera 15L and a right viewpoint image obtained by capturing the real space with the right camera 15R. The optical axes PL and PR of the imaging lenses 15a may be parallel to each other or they may have a convergence angle therebetween.

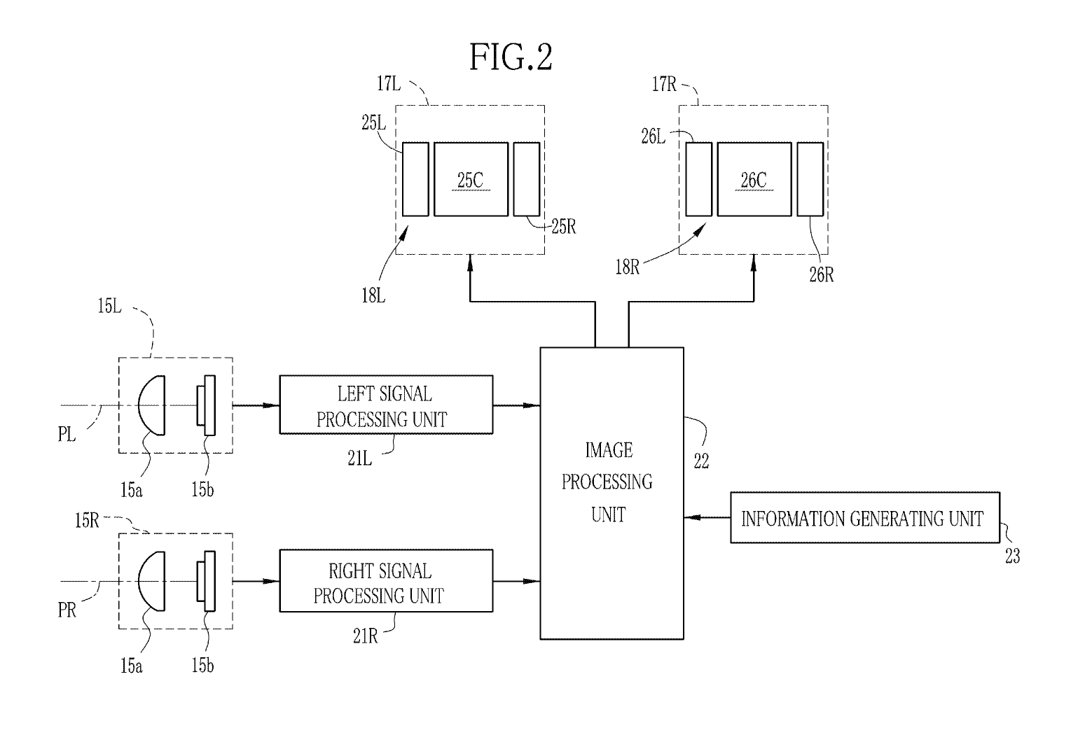

The display units 17L and 17R include, for example, an LCD (liquid crystal display) unit 18L for the left eye, an LCD unit 18R for the right eye (see FIG. 2) and ocular optical systems (not shown), and are provided in front of the corresponding left and right eyes. Various kinds of image processing are performed on the stereo image captured by the camera unit 15, and AR information is superimposed on the processed stereo image. Then, the image is displayed on the LCD units 18L and 18R, and the wearer observes the image displayed on the LCD units 18L and 18R through the ocular optical systems.

As shown in FIG. 2, the left camera 15L includes the imaging lens 15a and an image sensor 15b. A wide-angle lens that has a large angle of view and is capable of providing a wide visual field is used as the imaging lens 15a. In this embodiment, a wide-angle lens having a focal length of 20 mm and an angle of view of 94° (35 mm film camera equivalent focal length) is used as the imaging lens 15a. The image sensor 15b is a CCD type or a MOS type, converts an object image formed by the imaging lens 15a into an electric signal, and outputs a left viewpoint image. The right camera 15R has the same structure as that of the left camera 15L, includes the imaging lens 15a and an image sensor 15b, and outputs a right viewpoint image.

In order to provide a wide visual field, it is preferable that the focal length of a wide-angle lens used as the imaging lens 15a be as small as possible. For example, it is preferable that a wide-angle lens with a focal length of 20 mm or less be used as the imaging lens 15a. A diagonal fish-eye lens or a circular fish-eye lens with an angle of view of about 180° may be used as the wide-angle lens. For example, in order to record an object in the real space, a zoom lens may be used as the imaging lens 15a to ensure a focal length required for the recording.

A left signal processing unit 21L performs, for example, a noise removing process, a signal amplifying process, and a digital conversion process on the signal output from the left camera 15L. In addition, the left signal processing unit 21L performs various kinds of processes, such as a white balance process, on the digitalized left viewpoint image. The left viewpoint image is transmitted from the left signal processing unit 21L to an image processing unit 22. Similarly to the left signal processing unit 21L, a right signal processing unit 21R performs various kinds of processing on the right viewpoint image and outputs the processed right viewpoint image to the image processing unit 22.

The image processing unit 22 extracts a main image and a sub-image from each viewpoint image, and performs a process of correcting the distortion of the main image and an AR information composition process, which will be described in detail below. A left sub-image and a right sub-image are extracted as the sub-image. The main image and the sub-image are transmitted to each of the display units 17L and 17R.

An information generating unit 23 includes sensors that detect the position or imaging direction (for example, a direction and an angle of elevation) of the camera unit 15, and generates AR information including, for example, the description of an object in the real space during imaging, on the basis of the detection result of the sensors. The AR information includes composition control information indicating a position on the image where the AR image will be composed. The AR information is acquired from an external server that stores various kinds of AR information through, for example, a wireless communication unit (not shown). The AR information is transmitted from the information generating unit 23 to the image processing unit 22.

As described above, the left display unit 17L includes the LCD unit 18L and the ocular optical system. The LCD unit 18L includes a main screen 25C and left and right screens 25L and 25R, which are sub-screens. The main screen and the sub-screens are LCDs. Each of the screens includes a driving circuit (not shown) and displays an image on the basis of input data. The main image and the sub-image obtained from the left viewpoint image are displayed on the left display unit 17L. The main image is displayed on the main screen 25C, and the left sub-image and the right sub-image are respectively displayed on the left screen 25L and the right screen 25R.

In the LCD unit 18L, the main screen 25C is provided at the center, the left screen 25L is provided on the left side of the main screen 25C, and the right screen 25R is provided on the right side of the main screen 25C. The wearer views the LCD unit 18L having the above-mentioned structure through the ocular optical system to observe the main image substantially in front of the left eye and observe the left and right sub-images on the left and right sides of the main image, respectively. For example, the display surface of one LCD may be divided, and the main image and the sub-images may be displayed on the divided display surfaces such that the wearer can observe the images in the same way as described above.

The right display unit 17R has the same structure as that of the left display unit 17L and includes the LCD unit 18R and the ocular optical system. In addition, the LCD unit 18R includes a main screen 26C and left and right screens 26L and 26R, which are sub-screens. A main image, a left sub-image, and a right sub-image obtained from the right viewpoint image are displayed on the main screen and the sub-screens. Each image displayed on the LCD unit 18R is observed by the right eye through the ocular optical system.

The observation sizes of the main image and each sub-image or the position with respect to the visual field of the wearer are adjusted by, for example, the size or arrangement of each screen of the LCD units 18L and 18R and the magnifying power of the ocular optical system, such that the main image is suitable for stereoscopic vision and each sub-image is not suitable for stereoscopic vision, but is observed substantially in the visual field. It is preferable that the main image be adjusted such that the main image is observed substantially in the same visual field as that in which the person can clearly view the image with one eye. In this embodiment, the visual field in which the main image can be clearly observed is 46 degrees. In addition, the sizes of the sub-screens 25L and 26R, the positional relationship between the sub-screens 25L and 26R and the main screens 25C and 26C, and the ocular optical system are adjusted, such that each sub-image is observed outside the visual field in which the image can be clearly viewed.

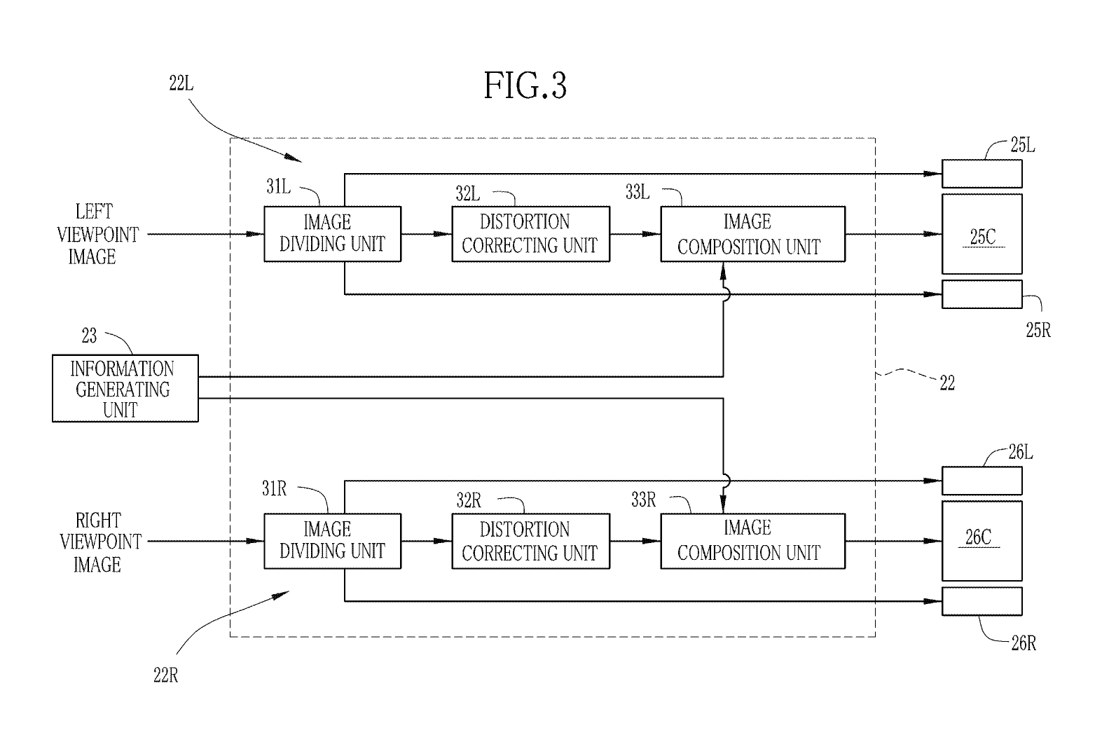

As shown in FIG. 3, the image processing unit 22 includes a left image processing system 22L that processes the left viewpoint image and a right image processing system 22R that processes the right viewpoint image.

The left image processing system 22L includes an image dividing unit 31L, a distortion correcting unit 32L, and an image composition unit 33L. The image dividing unit 31L receives the left viewpoint image and extracts the main image, the left sub-image, and the right sub-image from the left viewpoint image. The image dividing unit 31L extracts a central portion of the left viewpoint image as the main image, and extracts the left and right peripheral portions of the left viewpoint image as the left sub-image and the right sub-image. The left sub-image and the right sub-image are extracted such that a portion of the range of each sub-image overlaps the range of the main image.

The distortion correcting unit 32L receives the main image from the image dividing unit 31L. The distortion correcting unit 32L corrects the main image such that the distortion of the imaging lens 15a is removed. Correction parameters for removing the distortion of an image due to the distortion of the imaging lens 15a are set to the distortion correcting unit 32L, and the distortion correcting unit 32L uses the correction parameters to correct the distortion of the main image. The correction parameters are predetermined on the basis of, for example, the specifications of the imaging lens 15a.

The correcting process performed on the main image is not performed on each sub-image in order to ensure an image size that is easy to be viewed and ensure a sufficient amount of information regarding the displayed real space while displaying an image on the display screen with a limited size.

The image composition unit 33L receives the main image whose distortion has been corrected by the distortion correcting unit 32L and the AR information from the information generating unit 23. The image composition unit 33L composes the AR information with the main image on the basis of the composition control information included in the AR information to generate a main image on which the AR information is superimposed. In addition, the image composition unit 33L composes the AR information considering parallax from the right viewpoint image, such that the AR information is stereoscopically viewed, similarly to the main image. For example, the AR information may be composed with the sub-image.

The right image processing system 22R includes an image dividing unit 31R, a distortion correcting unit 32R, and an image composition unit 33R. The units of the right image processing system 22R have the same structure as those of the left image processing system 22L except that image processing is performed on the right viewpoint image. The units of the right image processing system 22R extract the main image and the sub-images from the right viewpoint image, correct the distortion of the main image, and compose the AR information with the main image.

Each image from the left image processing system 22L is transmitted to the LCD unit 18L. The main image is displayed on the main screen 25C, the left sub-image is displayed on the left screen 25L, and the right sub-image is displayed on the right screen 25R. Each image from the right image processing system 22R is transmitted to the LCD unit 18R. The main image is displayed on the main screen 26C, the left sub-image is displayed on the left screen 26L, and the right sub-image is displayed on the right screen 26R.

As described above, the main image obtained from the left viewpoint image is displayed on the main screen 25C observed by the left eye, and the main image obtained from the right viewpoint image is displayed on the main screen 26C observed by the right eye. In this way, the distortion-corrected main image is stereoscopically viewed. The left sub-image and the right sub-image have a parallax therebetween and are displayed on the left screens 25L and 26L and the right screens 25R and 26R. However, since the sub-images are displayed at positions deviating from the center of the visual field of the wearer, they are not stereoscopically viewed.

Since the left image and the right image are not stereoscopically displayed, for example, the left image obtained from the left viewpoint image may be displayed on the left screens 25L and 26L and the right image obtained from the right viewpoint image may be displayed on the right screens 25R and 26R. In addition, it is also possible to prevent the right image from being displayed on the left LCD unit 18L and prevent the left image from being displayed on the right LCD unit 18R.

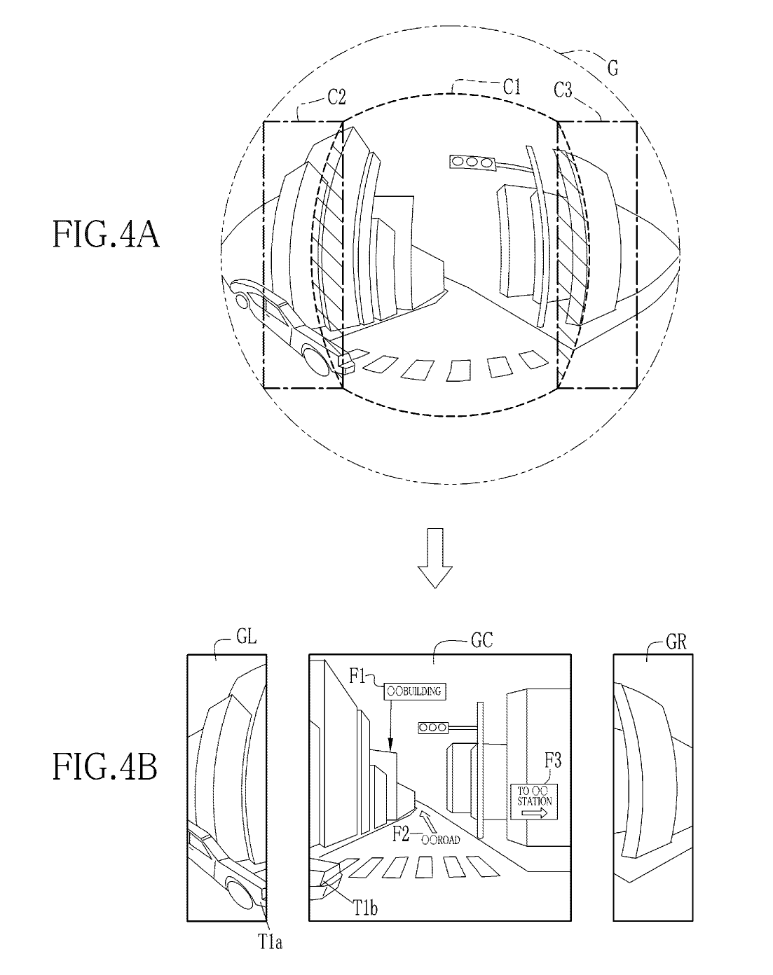

For example, as shown in FIG. 4A, the main image is extracted from a main image region C1 partitioned at the center of a right or left viewpoint image G. The main image region C1 is arranged such that the center position thereof is aligned with the center position (the position of the optical axis of the imaging lens 15a) of the viewpoint image G, and the center position of the corrected main image is aligned with that of the viewpoint image G.

The main image region C1 has a barrel shape, which is a rectangle in a swollen shape, and a distortion-corrected main image GC has a rectangular shape, as shown in FIG. 4B. As such, the main image GC is displayed such that the distortion thereof is corrected. In addition, for example, AR information F1 indicating the name of a building, AR information F2 indicating the name of a road, and AR information F3 indicating the direction of an adjacent station are composed and displayed.

The periphery of the viewpoint image is partitioned into a rectangular left sub-image region C2 disposed on the left side of the main image region C1 and a rectangular right sub-image region C3 disposed on the right side of the main image region C1. A left sub-image GL is extracted from the left sub-image region C2 and a right sub-image GR is extracted from the right sub-image region C3. The distortion of the left and right sub-images GL and GR is not corrected, and the left and right sub-images GL and GR are displayed in a shape similar to a rectangle in the sub-image regions C2 and C3, respectively.

As shown in a hatched portion in FIG. 4A, a portion of the right side of the left sub-image region C2 and a portion of the left side of the right sub-image region C3 are partitioned so as to overlap the main image region C1. In this way, the object image in the main image and the object image in the sub-image partially overlap each other, and it becomes easy to grasp the relation between the object image in the displayed main image and the object image in the displayed sub-image. In the example shown in FIG. 4A, an object image T1a of a vehicle including the leading end thereof is displayed in the left sub-image GL, and an object image T1b of the leading end of the vehicle is displayed in the main image GC.

Next, the operation of the above-mentioned structure will be described. When the HMD 10 is worn and a power supply is turned on, an operation of capturing a motion picture starts. That is, the left camera 15L and the right camera 15R start to capture the real space through the imaging lenses 15a. Each frame of the captured left viewpoint image and the captured right viewpoint image is sequentially transmitted to the image processing unit 22 through the signal processing units 21L and 21R.

The left viewpoint image is sequentially input to the left image processing system 22L, and the image dividing unit 31L extracts the main image, the left sub-image, and the right sub-image from the left viewpoint image. In this case, each of the sub-images is extracted such that a portion of the sub-image overlaps the main image. The extracted main image is transmitted to the distortion correcting unit 32L, and the distortion correcting unit 32L corrects the distortion of the imaging lens 15a and transmits the main image without any aberration to the image composition unit 33L.

During image capture, the information generating unit 23 detects, for example, the position or imaging direction of the camera unit 15. Then, the information generating unit 23 specifies, for example, a building or a road in the real space that is currently being captured by the camera unit 15 on the basis of the detection result, and generates the AR information thereof. Then, the AR information is transmitted to the image composition units 33L and 33R.

When the AR information is input to the image composition unit 33L, the AR information is composed at a composition position on the main image based on the composition control information included in the AR information. When a plurality of AR information items are input, each of the AR information items is composed with the main image. Then, the main image having the AR information composed therewith and each sub-image from the image dividing unit 31L are transmitted to the LCD unit 18L.

The right viewpoint image is sequentially input to the right image processing system 22R, and the image dividing unit 31R extracts the main image, the left sub-image, and the right sub-image from the right viewpoint image, similar to the above. Among the images, the distortion of the main image is corrected by the distortion correcting unit 32R, and the AR information is composed with the main image by the image composition unit 33R. Then, the main image having the AR information composed therewith and each sub-image from the image dividing unit 31R are transmitted to the LCD unit 18R.

As described above, the left and right main images and each sub-image obtained from each viewpoint image are transmitted to the LCD units 18L and 18R. Then, the main image generated from the left viewpoint image is displayed on the left main screen 25C and the main image generated from the right viewpoint image is displayed on the right main screen 26C. In addition, the left sub-image generated from the left viewpoint image is displayed on the left screen 25L disposed on the left side of the main screen 25C, and the right sub-image generated from the left viewpoint image is displayed on the right screen 25R disposed on the right side of the main screen 25C. The left sub-image generated from the left viewpoint image is displayed on the left screen 26L disposed on the left side of the main screen 26C, and the right sub-image generated from the right viewpoint image is displayed on the right screen 26R disposed on the right side of the main screen 26C.

The main image and each sub-image displayed on each screen are updated in synchronization with the image capture of the camera unit 15. Therefore, the wearer can observe the main image and each sub-image as a motion picture through the ocular optical system. When changing the viewing direction, the wearer can observe the main image and each sub-image which are changed with the change in the viewing direction.

By observing the left and right main images having a parallax therebetween, the wearer can stereoscopically view the main image and thus can observe the real space with a sense of depth. In addition, the wearer can observe the distortion-corrected main image and the AR information. Therefore, the wearer can move or work while observing the main image or the AR information composed with the main image.

The wearer can also view the left image and the right image disposed on the left and right sides of the main image which is observed in the above-mentioned way. The left image and the right image include a large amount of information of the left and right real spaces of the wearer. As described above, the distortion of the left and right images is not corrected and the left and right images are not stereoscopically viewed. However, the left and right images are sufficient for the wearer to sense things in the left-right direction of the wearer in the real space. For example, the wearer can recognize an approaching vehicle early. In this case, since each sub-image is displayed such that a portion thereof overlaps the main image, it is easy to grasp the relation between an object image in the sub-image and an object image in the main image.

### Second Embodiment

A second embodiment in which the display of the main image is switched between the 3D mode and the 2D mode according to the motion of the head of the wearer will be described below. Structures other than the following structure are the same as those in the first embodiment. Substantially the same components are denoted by the same reference numerals and a description thereof will be omitted.

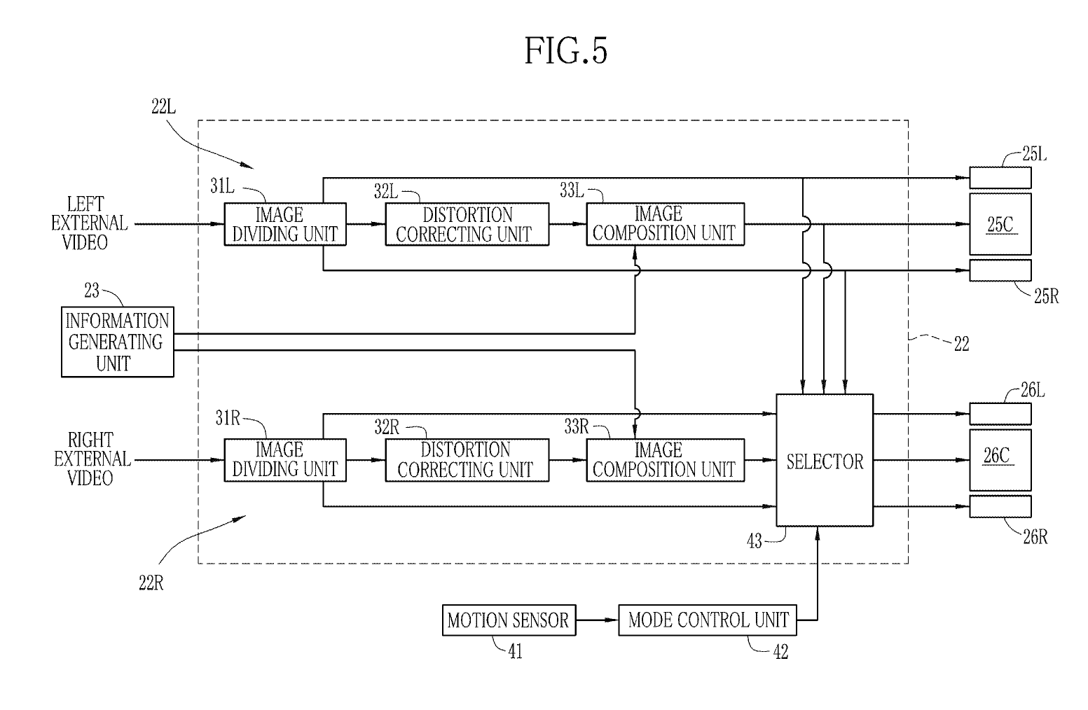

In this embodiment, as shown in FIG. 5, a motion sensor 41, a mode control unit 42, and a selector 43 are provided. The motion sensor 41 is, for example, an acceleration sensor or an angular rate sensor, and detects the motion of the head of the wearer. In addition to the motion (for example, the rotation or linear motion) of the head of the wearer, the motion of the wearer accompanying the movement of the head is detected as the motion of the head.

The detection result of the motion sensor 41 is transmitted to the mode control unit 42. The mode control unit 42 determines the display mode on the basis of the detection result of the motion sensor 41 and controls the selector 43. The display mode includes the 3D mode in which the main image is three-dimensionally displayed and the 2D mode in which the main image is two-dimensionally displayed. In the 3D mode, similar to the first embodiment, the main image obtained from the left viewpoint image is displayed on the main screen 25C, and the main image obtained from the right viewpoint image is displayed on the main screen 26C, thereby displaying a stereo image. In the 2D mode, the main image obtained from one of the left and right viewpoint images, in this embodiment, the left viewpoint image is displayed on the main screen 25C and the main screen 26C such that a two-dimensional main image is observed.

The main image and each sub-image from the right image processing system 22R and the main image and each sub-image from the left image processing system 22L are input to the selector 43 serving as a display switching unit. The selector 43 selects one of the image processing systems and outputs the main image and each sub-image of the selected image processing system to the LCD unit 18R. In the 3D mode, the selector 43 selects the right image processing system 22R and outputs the main image and each sub-image from the right image processing system 22R to the LCD unit 18R. In the 2D mode, the selector 43 selects the left image processing system 22L and outputs the main image and each sub-image from the left image processing system 22L to the LCD unit 18R.

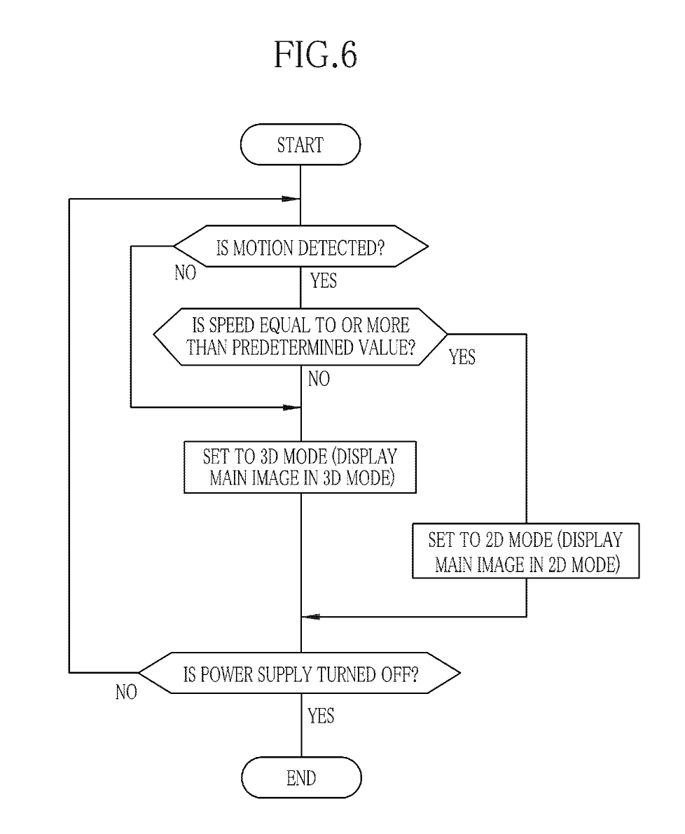

As shown in FIG. 6, the mode control unit 42 sets the display mode to the 2D mode when detecting that the head of the wearer is moved at a speed equal to or more than a predetermined value, for example, the normal walking speed of the wearer, on the basis of the detection result of the motion sensor 51, and sets the display mode to the 3D mode when detecting that the head of the wearer is moved at a speed less than the predetermined value.

According to this embodiment, the main image and each sub-image from the left image processing system 22L are transmitted to and displayed on the LCD unit 18L, regardless of whether the motion of the head is detected. In this way, the main image obtained from the left viewpoint image is displayed on the main screen 25C. When the wearer walks slowly at a speed less than the predetermined value or is at a standstill, the display mode is changed to the 3D mode, and the selector 43 transmits the main image and each sub-image from the right image processing system 22R to the LCD unit 18R. As a result, the main image obtained from the right viewpoint image is displayed on the main screen 26C, and the wearer can stereoscopically view the main image. In this way, the wearer can slowly view, for example, a peripheral building with a sense of depth.

When the wearer walks, for example, at a speed equal to or more than the predetermined value, the display mode is changed to the 2D mode, and the selector 43 transmits the main image and each sub-image from the left image processing system 22L to the LCD unit 18R. As a result, the main image obtained from the left viewpoint image is displayed on both the main screens 25C and 26C. In this way, when the wearer is likely to contact a peripheral obstacle during movement, the display mode is changed to the 2D mode in which it is relatively easy for the wearer to view the image such that the wearer easily avoids the obstacle.

In the above-described embodiment, the display mode is changed to the 3D mode or the 2D mode according to whether the moving speed of the wearer is equal to or more than a predetermined value, but the present invention is not limited thereto. For example, the display mode may be changed to the 3D mode or the 2D mode according to whether the wearer is moving. In addition, when the wearer has moved for a predetermined period of time or more and a predetermined period of time or more has elapsed from the stopping of the movement, the display mode may be changed to the 3D mode or the 2D mode. In addition, in the 2D mode according to this embodiment, the main image and sub-images obtained from the left viewpoint image are displayed instead of the main image and sub-images obtained from the right viewpoint image. However, only the main image may be obtained from the left viewpoint image. Needless to say, in the 2D mode, the image obtained from the right viewpoint image may be displayed instead of the image obtained from the left viewpoint image.

### Third Embodiment

A third embodiment in which the display of the main image is changed to the 3D mode or the 2D mode according to the movement of the viewpoint of the wearer will be described below. Structures other than the following structure are the same as those in the second embodiment. Substantially the same components are denoted by the same reference numerals and a description thereof will be omitted.

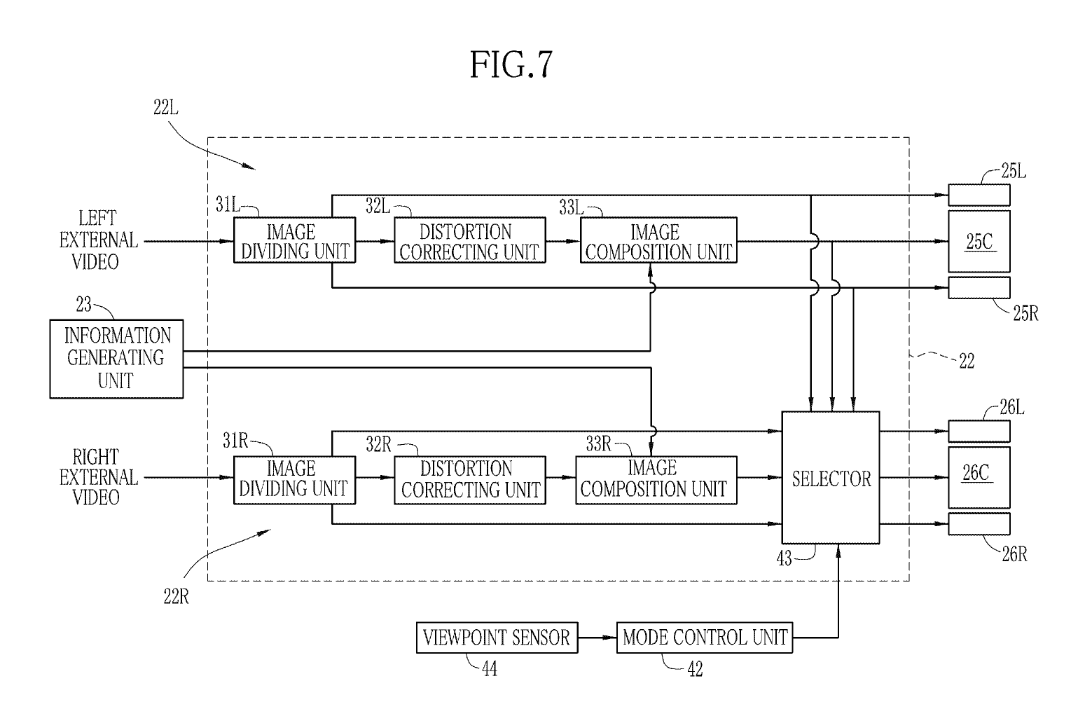

In this embodiment, as shown in FIG. 7, a viewpoint sensor 44 is provided in an HMD 10. The viewpoint sensor 44 includes, for example, an infrared ray emitting unit that emits infrared rays to an eyeball of the wearer and a camera that captures the image of the eyeball, and a viewpoint is detected by using a known corneal reflection method. The viewpoint may be detected by other methods.

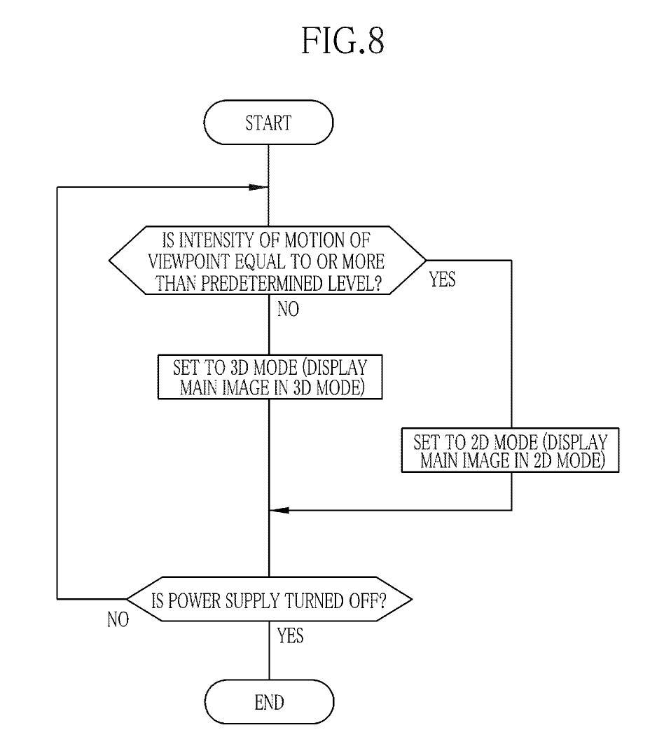

The mode control unit 42 controls the selector 43 on the basis of the detection result of the viewpoint sensor 44 to change the display mode of the HMD 10 between the 3D mode and the 2D mode. As shown in FIG. 8, the mode control unit 42 changes the display mode according to the degree (level) of the intensity of the movement of the viewpoint. When the intensity of the movement of the viewpoint is equal to or more than a predetermined level, the display mode is changed to the 2D mode in which the wearer easily views the image even in this state. When the intensity of the movement of the viewpoint is less than the predetermined level, the display mode is changed to the 3D mode. The intensity of the movement of the viewpoint may be determined by, for example, the movement distance or movement range of the viewpoint per unit time. When the movement distance or the movement range is large, it may be determined that the movement of the viewpoint is large.

According to this embodiment, for example, when the wearer greatly moves the viewpoint to find a building, the display mode is changed to the 2D mode in which the wearer can easily view the image even when the movement of the viewpoint is great. When the wearer gazes at a building, the display mode is changed to the 3D mode in which the wearer can easily view the image in this state.

### Fourth Embodiment

A fourth embodiment in which notification is performed when there is an approaching object in the left screen and the right screen will be described below. Structures other than the following structure are the same as those in the first embodiment. Substantially the same components are denoted by the same reference numerals and a description thereof will be omitted.

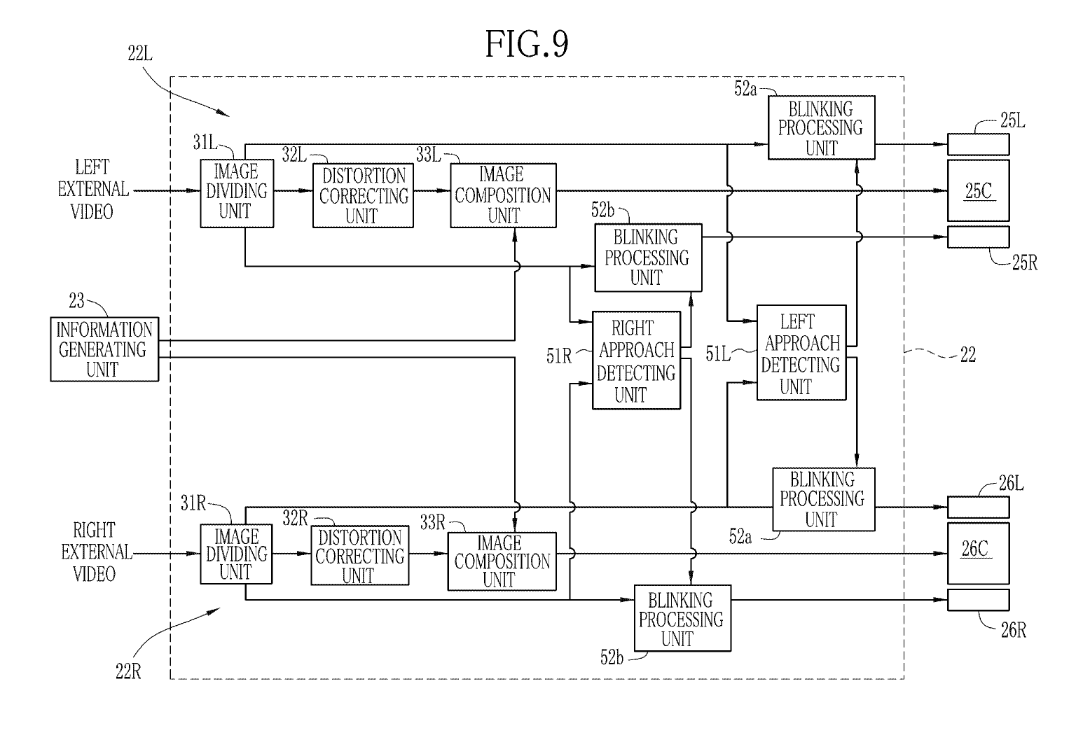

As shown in FIG. 9, an image processing unit 22 includes a left approach detecting unit 51L, a right approach detecting unit 51R, and blinking processing units 52a and 52b. The left approach detecting unit 51L detects an object that approaches the wearer in the left image on the basis of each left image from the image processing systems 22L and 22R. In the detection, the parallax between the left images is used to measure the distance of the object image in the left image to the wearer using a known stereo method, and a distance variation is measured on the basis of the distance obtained from the left image that is sequentially input. When the distance is gradually reduced, it is determined that an object corresponding to the object image is approaching. When detecting the approaching object in the left image, the left approach detecting unit 51L transmits the distance information of the object and region information indicating the region of the image of the object to each of the blinking processing units 52a.

Similarly to the left approach detecting unit 51L, the right approach detecting unit 51R detects an object that approaches the wearer in the right image on the basis of each right image from the image processing systems 22L and 22R. When detecting the approaching object in the right image, the right approach detecting unit 51R transmits the distance information of the object and region information indicating the region of the image of the object to each of the blinking processing units 52b.

When receiving the distance information and the region information from the left approach detecting unit 51L, the blinking processing unit 52a performs image processing on each left image from the image processing systems 22L and 22R such that the object image in the left image indicated by the region information blinks. When receiving the distance information and the region information from the right approach detecting unit 51R, the blinking processing unit 52b performs image processing on each right image from the image processing systems 22L and 22R such that the object image in the right image indicated by the region information blinks.

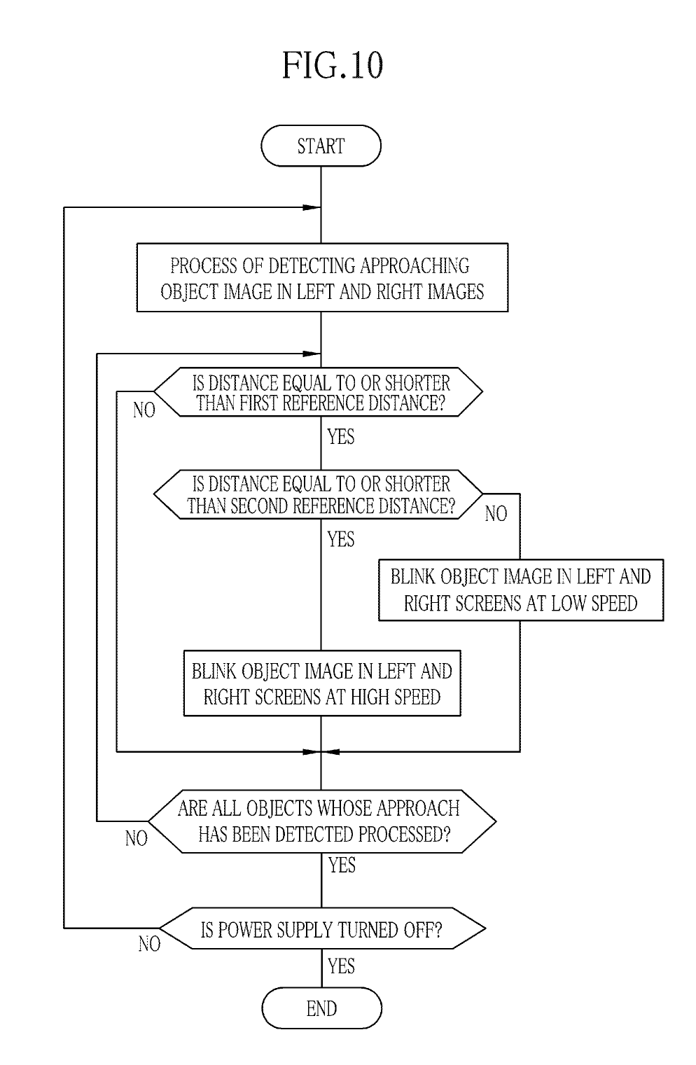

The blinking processing units 52a and 52b control the blinking speed according to the distance information. As shown in FIG. 10, a first reference distance and a second reference distance shorter than the first reference distance are set to the blinking processing units 52a and 52b. When the distance of the object indicated by the distance information is more than the first reference distance, the blinking processing units 52a and 52b do not blink the image of the object. When the distance of the object is equal to or less than the first reference distance, the blinking processing units 52a and 52b start to blink the image of the object. When the distance of the object is equal to or less than the first reference distance and is more than the second reference distance, the blinking processing units 52a and 52b blink the image of the object at a low speed. When the distance of the object is equal to or less than the second reference distance, the blinking processing units 52a and 52b blink the image of the object at a high speed. In this way, the approach of the object is notified to the wearer according to the distance and a warning against contact is given to the wearer.

In this embodiment, the image of the object blinks. However, simply, the right image or the left image from which an approaching object is detected may blink. In addition, the approach of the object may be notified in ways other than blinking. For example, the image of an approaching object may have an appropriate color, or an arrow indicating the movement direction of the object may be composed with the object image and the image may be displayed. Further, this embodiment may be combined with the above-described second or third embodiment.

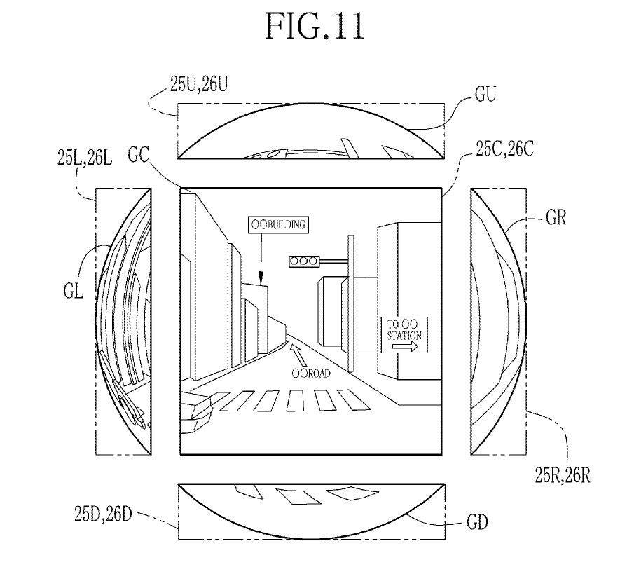

In the above-described embodiments, the sub-images are used as the left and right images of the main image. However, for example, as shown in FIG. 11, the upper, lower, left, and right sub-images may be displayed. In the example shown in FIG. 11, the left screens 25L and 26L and the right screens 25R and 26R are arranged on the left and right sides of the main screens 25C and 26C, and upper screens 25U and 26U and lower screens 25D and 26D are arranged on the upper and lower sides of the main screens 25C and 26C. An upper sub-image GU above the main image GC is displayed on the upper screens 25U and 26U, and a lower sub-image GD below the main image GC is displayed on the lower screens 25D and 26D. Actually, images having a parallax therebetween are displayed on the main screen and the upper, lower, left, and right screens, but the images having the parallax therebetween are not shown in FIG. 11.

Various changes and modifications are possible in the present invention and may be understood to be within the present invention.

What is claimed is:

1. A head-mounted display device that is worn on the head of a wearer and is used, comprising:
an imaging unit including a pair of left and right cameras each of which captures an image of a real space through a wide-angle lens from left and right viewpoints substantially the same as those of a wearer, the left camera capturing a left viewpoint image, and the right camera capturing a right viewpoint image;
an image dividing unit extracting a central portion of each of the left and right viewpoint images as a main image and a peripheral portion of each of the left and right viewpoint images as a sub-image;
a distortion correcting unit correcting distortion of the wide-angle lens for the main image;
a main image display unit including a left main screen which is provided in front of the left eye of the wearer and displays the main image obtained from the left viewpoint image, and a right main screen which is provided in front of the right eye of the wearer and displays the main image obtained from the right viewpoint image, the main image display unit stereoscopically displaying the main image; and
a sub-image display unit including a sub-screen that displays the sub-image around each of the main screens.

2. The head-mounted display device according to claim 1, wherein the image dividing unit extracts the sub-image from each of the left and right viewpoint images so as to overlap the sub-image with a portion of the main image.

3. The head-mounted display device according to claim 1, wherein
the image dividing unit extracts the sub-images from left and right sides of the main image, and
the sub-image display unit displays the corresponding sub-images on the sub-screens arranged on left and right sides of the main screen.

4. The head-mounted display device according to claim 1, wherein
the image dividing unit extracts the sub-images from upper, lower, left, and right sides of the main image, and
the sub-image display unit displays the corresponding sub-images on the sub-screens arranged on upper, lower, left, and right sides of the main screen.

5. The head-mounted display device according to claim 1, further comprising:
an approach detecting unit detecting an object approaching the wearer using a parallax between the corresponding sub-images obtained from the right viewpoint image and the left viewpoint image; and
a notifying unit displaying a notice on the sub-screen on which the sub-image is displayed when an object approaching the wearer is detected in the sub-image.

6. The head-mounted display device according to claim 1, further comprising:
an additional information composition unit superimposing additional information on the main image or the sub-image to display the main image or the sub-image having the additional information superimposed thereon.

7. The head-mounted display device according to claim 1, further comprising:
a motion detecting unit detecting motion of the head of the wearer;
a mode control unit setting a display mode to a 3D mode or a 2D mode on the basis of the detection result of the motion detecting unit; and
a display switching unit displaying the main image obtained from the left viewpoint image on the left main screen and the main image obtained from the right viewpoint image on the right main screen in the 3D mode, and displays the main image obtained from one of the left and right viewpoint images on each of the left main screen and the right main screen in the 2D mode.

8. The head-mounted display device according to claim 7, wherein when the motion detecting unit detects motion of the head of the wearer, the mode control unit sets the display mode to the 3D mode, and when the motion detecting unit does not detect the motion of the head of the wearer, the mode control unit sets the display mode to the 2D mode.

9. The head-mounted display device according to claim 7, wherein when the speed of the motion detected by the motion detecting unit is equal to or more than a predetermined value, the mode control unit sets the display mode to the 3D mode, and when the speed of the motion is less than the predetermined value, the mode control unit sets the display mode to the 2D mode.

10. The head-mounted display device according to claim 7, wherein the image dividing unit extracts the sub-image from each of the left and right viewpoint images so as to overlap the sub-image with a portion of the main image.

11. The head-mounted display device according to claim 7, wherein
the image dividing unit extracts the sub-images from left and right sides of the main image, and
the sub-image display unit displays the corresponding sub-images on the sub-screens arranged on left and right sides of the main screen.

12. The head-mounted display device according to claim 7, wherein
the image dividing unit extracts the sub-images from upper, lower, left, and right sides of the main image, and
the sub-image display unit displays the corresponding sub-images on the sub-screens arranged on upper, lower, left, and right sides of the main screen.

13. The head-mounted display device according to claim 7, further comprising:
an approach detecting unit detecting an object approaching the wearer using a parallax between the corresponding sub-images obtained from the right viewpoint image and the left viewpoint image; and
a notifying unit displaying a notice on the sub-screen on which the sub-image is displayed when an object approaching the wearer is detected in the sub-image.

14. The head-mounted display device according to claim 7, further comprising:
an additional information composition unit superimposing additional information on the main image or the sub-image to display the main image or the sub-image having the additional information superimposed thereon.

15. The head-mounted display device according to claim 1, further comprising:
a viewpoint detecting unit detecting a viewpoint position of the wearer on the main image or the sub-image;
a mode control unit selecting a 3D mode or a 2D mode as a display mode on the basis of the detection result of the viewpoint detecting unit; and
a display switching unit displaying the main image obtained from the left viewpoint image on the left main screen and the main image obtained from the right viewpoint image on the right main screen in the 3D mode, and displaying the main image obtained from one of the left and right viewpoint images on each of the left main screen and the right main screen in the 2D mode.

16. The head-mounted display device according to claim 15, wherein the image dividing unit extracts the sub-image from each of the left and right viewpoint images so as to overlap the sub-image with a portion of the main image.

17. The head-mounted display device according to claim 15, wherein
the image dividing unit extracts the sub-images from left and right sides of the main image, and
the sub-image display unit displays the corresponding sub-images on the sub-screens arranged on left and right sides of the main screen.

18. The head-mounted display device according to claim 15, wherein
the image dividing unit extracts the sub-images from upper, lower, left, and right sides of the main image, and
the sub-image display unit displays the corresponding sub-images on the sub-screens arranged on upper, lower, left, and right sides of the main screen.

19. The head-mounted display device according to claim 15, further comprising:
an approach detecting unit detecting an object approaching the wearer using a disparity between the corresponding sub-images obtained from the right viewpoint image and the left viewpoint image; and
a notifying unit displaying a notice on the sub-screen on which the sub-image is displayed when an object approaching the wearer is detected in the sub-image.

20. The head-mounted display device according to claim 15, further comprising:
an additional information composition unit superimposing additional information on the main image or the sub-image to display the main image or the sub-image having the additional information superimposed thereon.
